(19) United States
(12) Patent Application Publication
(10) Pub. No.: US 2010/0204484 A1
(43) Pub. Date: Aug. 12, 2010

(54) CRYSTALLINE SYNTHETIC INTERMEDIATE FOR PREPARATION OF A DPP-IV INHIBITOR AND METHOD OF PURIFICATION THEREOF

(75) Inventor: Zhen-Ping Wu, La Jolla, CA (US)

Correspondence Address: SCHWEGMAN, LUNDBERG & WOESSNER, P.A., P.O. BOX 2938, MINNEAPOLIS, MN, 55402, US

(73) Assignee: Phenomix Corporation, San Diego, CA (US)

(21) Appl. No.: 12/668,405

(22) PCT Filed: Jul. 11, 2008
(86) PCT No.: PCT/US08/69833

§ 371 Date: Mar. 31, 2010

Related U.S. Application Data
(60) Provisional application No. 60/959,226, filed on Jul. 12, 2007.

(51) Int. Cl. C07F 5/02

(52) U.S. Cl. 548/405

(57) ABSTRACT

The invention provides a crystalline form of a synthetic intermediate useful in the preparation of a DPP-IV inhibitor, a method for preparing the crystalline form of the intermediate, and a method of using the crystalline form of the intermediate in the preparation of the inhibitor.

### CROSS-REFERENCE TO RELATED APPLICATIONS

This application claims the priority of U.S. Ser. No. 60/959,226, filed Jul. 12, 2007, which is incorporated herein by reference in its entirety.

### FIELD OF THE INVENTION

The field of the invention is a crystalline form of a synthetic intermediate, the intermediate being useful in the preparation of a known inhibitor of the enzyme DPP-IV, methods of preparing the crystalline form of the intermediate, and methods of using the crystalline form of the intermediate in the preparation of a stereoisomerically pure form of the known DPP-IV inhibitor, pyrrolidin-3-ylglycylprolineboronic acid.

### BACKGROUND

The enzyme dipeptidyl peptidase IV (DPP-IV) is a member of the dipeptidyl peptidase family, which cleaves N-terminal dipeptide residues from proteins, particularly where the dipeptide includes an N-terminal penultimate proline or alanine residue. DPP-IV is believed to be involved in glucose control, as its peptidolytic action inactivates the insulotropic peptides glucagon-like peptide I (GLP-1) and gastric inhibitory protein (GIP). Inhibition of DPP-IV, such as with synthetic inhibitors in vivo, can serve to increase plasma concentrations of GLP-1 and GIP, and thus improve glucose control. Such synthetic inhibitors would therefore be useful in the treatment of Diabetes Mellitus and related conditions.

However, there exist other members of this DPP enzyme family including DPP-VII, DPP-VIII, DPP-IX, and FAP (fibroblast activation protein), which have similar substrate specificities to DPP-IV. Inhibition of certain of these enzymes, for example DPP-VIII and/or DPP-IX have been reported to cause toxic effects in mammals. Therefore, to be medicinally useful, inhibitors of DPP-IV must also exhibit selectivity for DPP-IV relative to other members of the DPP enzyme family.

Certain such selective DPP-IV inhibitors have been developed, as is disclosed in U.S. Pat. No. 7,317,109, issued Jan. 8, 2008, in the published PCT patent application, publication number WO2005/047297, published Nov. 16, 2006, and in U.S. Application Publication Nos. 2006/0258621, and 2006/0264401.

In certain of those applications, inhibition of DPP-IV by compounds of the structure of formula (I):

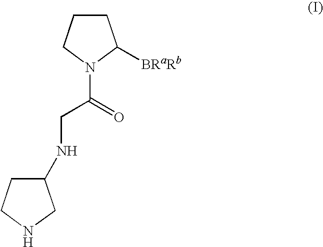

wherein R^{a} and R^{b} are OH, thus providing a boronic acid, or its salt or a protected form, is disclosed. The compound is referred to as a pyrrolidin-3-yl-glycyl-boro-proline. U.S. Pat. No. 7,317,109, issued Jan. 8, 2008, claims a compound of this structure and its use for selectively inhibiting DPP-IV, such as in a mammal with a malcondition that can be regulated or normalized by inhibition of DPP-IV, such as diabetes.

In PCT application Serial No. PCT/US2006/029451, by the inventors herein, a method of preparation of a steroisomerically pure form (IA) of compound (I) wherein R^{a} and R^{b} are each OH is provided.

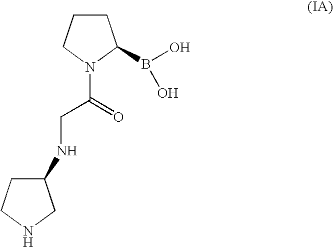

Coupling of an activated ester of compound (III) (3-(R)-benzyloxycarbonyl-carboxymethyl-amino)pyrrolidine-1-carboxylic acid benzyl ester) with the protected boro-proline (IV) (2-(R)-boroproline-(1S,2S,3R,5S)-pinanediol ester, prepared from (+)-pinanediol) yields coupling product bis-Cbz pinandiol boronate ester (V) (see Synthetic Scheme). By a boro-proline derivative is meant an analog of proline wherein the carboxylic acid moiety of the aminoacid has been replaced by a boronic acid moiety or a protected form thereof, such as a boronic ester. Removal of the Cbz groups by hydrogenolysis provides the pinandiol boronate ester (VI) (2(R)-1-{2-[(3R)-pyrrolidinylamino]-acetyl}-pyrrolidine-2-boronic acid (1S, 2S, 3R,5S)-pinanediol ester) and cleavage of the boronate ester groups provides the stereoisomerically pure DPP-IV inhibitory compound (IA) (2(R)-1-{[(3R)-pyrrolidinylamino]-acetyl}-pyrrolidine-2-boronic acid).

Copending patent application U.S. Pat. Ser. No. 60/893,842 by the inventors herein discloses a crystalline intermediate, the sodium salt of compound (III), and methods of preparation and use thereof Crystalline intermediates possess a desirable ease of purification and of handling on a large scale compared to oils and gums. Thus, there is a need for crystalline intermediates useful in the preparation of compound (IA) and other related DPP-IV inhibitory boronic acids.

### SUMMARY OF THE INVENTION

The present invention is directed to a crystalline form of compound (VI):

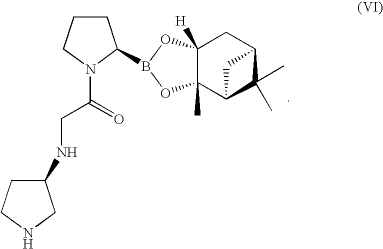

Compound (VI) is the stereochemically defined isomer 2(R)-1-{2-[(3R)-pyrrolidinylamino]-acetyl}-pyrrolidine-2-boronic acid (1S,2S,3R,5S)-pinanediol ester. The inventive crystalline form includes THF solvent. It is believed that the crystalline form is a crystalline THF solvate of the compound of formula (VI). The crystalline form is characterized by spectral data such as X-ray powder diffraction, nuclear magnetic resonance (NMR), infrared absorption spectroscopy (IR), and differential scanning calorimetry (DSC).

An embodiment of the invention concerns a method of preparing the inventive crystalline form by crystallization from a solvent, such as tetrahydrofuran. A sample of unpurified material is dissolved in warm THF, the volume reduced under vacuum, and the solution cooled to provide the crystalline material. The material can be further dried. The inventive method unexpectedly provides a pure and easy to handle crystalline intermediate in high yield, which is advantageous in that this intermediate can be used in preparation of a known selective inhibitor of DPP-IV in high purity and yield. The presence of THF in the crystalline solvate has been found not to interfere with its subsequent conversion to the DPP-IV inhibitor.

Another embodiment of the invention provides a method whereby the crystalline material can be used in the synthesis of a DPP-IV inhibitory material compound (IA), (2(R)-1-{[(3R)-pyrrolidinylamino]-acetyl}-pyrrolidine-2-boronic acid):

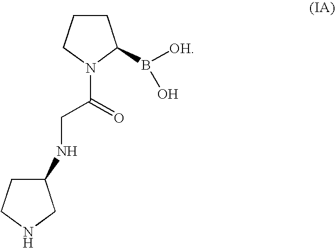

The inventive crystalline material of high purity, obtained by crystallization from THF, is well adapted for production of the DPP-IV inhibitory compound (IA) by an embodiment of the synthetic method.

### BRIEF DESCRIPTION OF THE DRAWINGS

FIG. 1 shows a proton nuclear magnetic resonance (NMR) spectrum of a CDCl₃ solution of the crystalline form of compound (VI).

FIG. 2 shows an infrared absorption (IR) spectrum of the crystalline form of compound (VI).

FIG. 3 shows a Differential Scanning Calorimetry (DSC) trace of the crystalline form of compound (VI).

FIG. 4 shows an X-ray powder diffraction pattern of the crystalline form of compound (VI).

### DETAILED DESCRIPTION

The present invention is directed to a crystalline form of a compound of formula (VI):

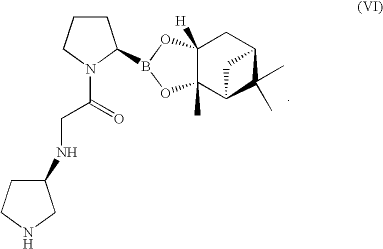

The inventive crystalline form, 2(R)-1-{2-[(3R)-pyrrolidinylamino]-acetyl}-pyrrolidine-2-boronic acid (1S,2S,3R,5S)-pinanediol ester, prepared by crystallization from a tetrahydrofuran solution, contains tetrahydrofuran even after drying under vacuum, and is believed to be a crystalline solvate of compound (VI). The crystalline form is believed to be at least about 99% pure, excepting residual solvent. By a crystalline solvate is meant a crystalline form in which solvent molecules occupy spatially defined positions in the crystalline unit cell.

A number of different solvents were evaluated while developing the present purification procedure, including THF, ethyl acetate, MTBE, MeOH, dichloromethane, heptane, isopropyl alcohol, isopropyl acetate, acetonitrile and combinations thereof.

THF unexpectedly proved to be the best solvent overall based on isolated product purity, impurity profile and yield. The unique and surprising performance was attributed to the unexpected formation of the THF solvate of compound (VI), which provided appropriate physiochemical characteristics for an effective and efficient purification by crystallization. The presence of THF in the solvated crystalline form of the invention was found to have no negative impact on the utility of the crystalline solvate form in the synthesis of the selective DPP-IV inhibitor of formula (IA), as illustrated below by the example.

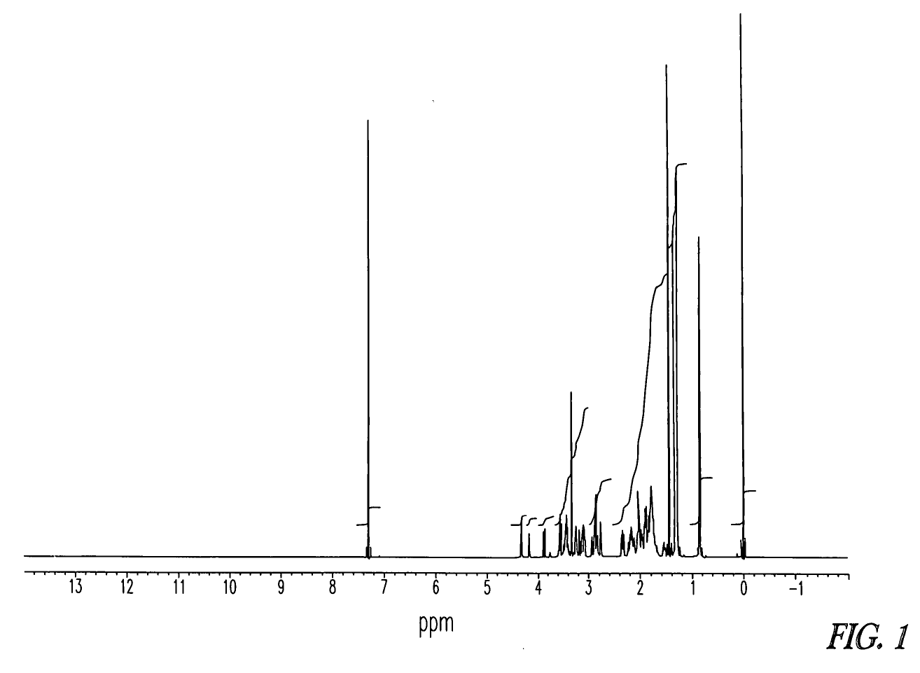

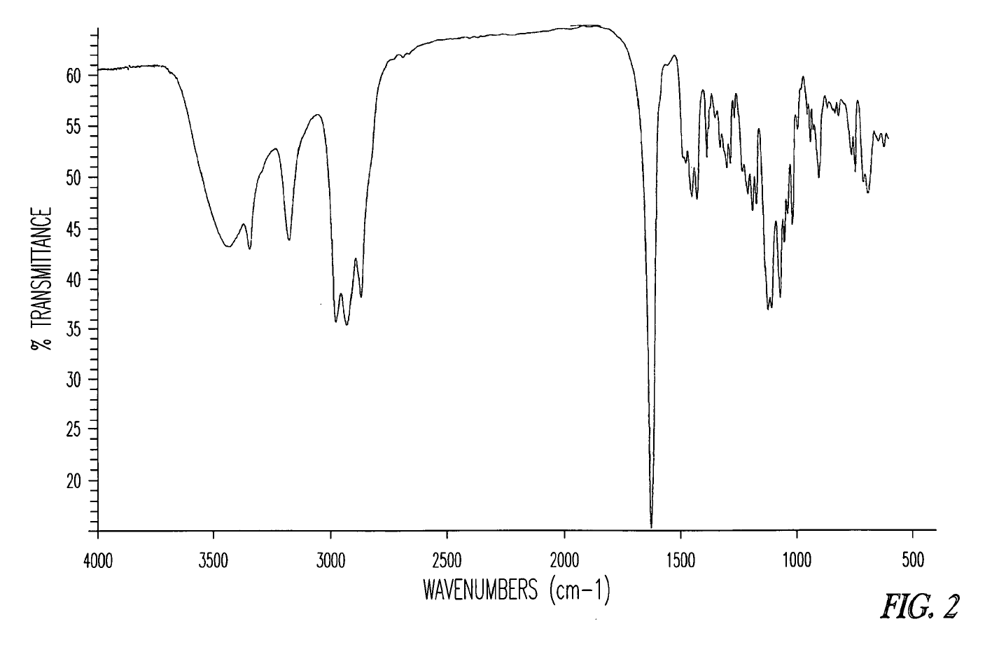

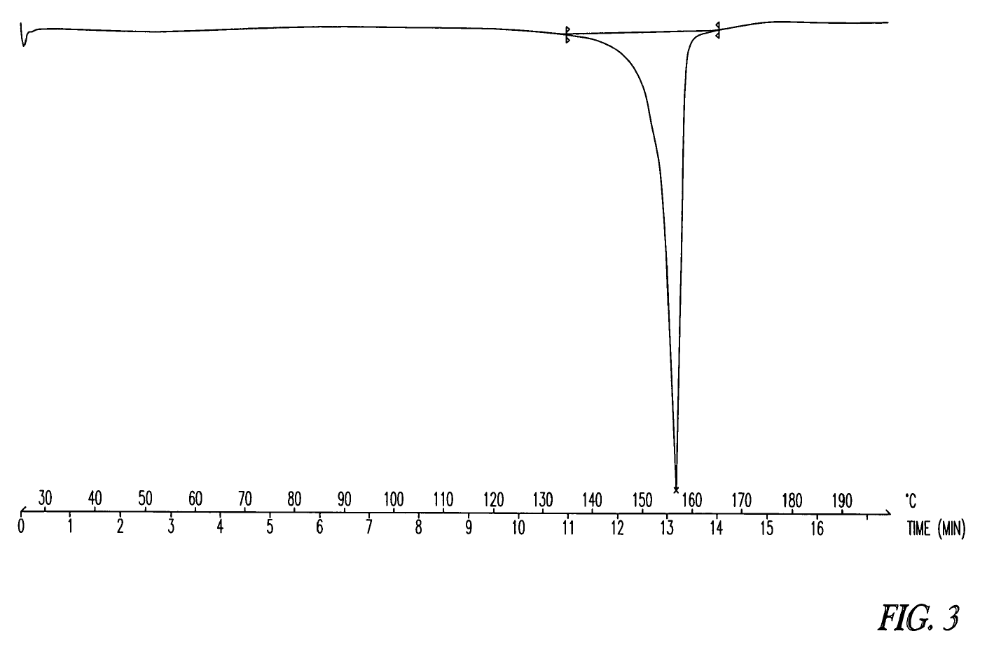

An embodiment of the invention provides the crystalline form of compound (VI) with the spectral characteristics and physical properties as described herein. As shown in FIG. 1, the proton nuclear magnetic resonance (NMR) spectrum of a CDCl₃ solution of the crystalline form shows the expected resonances, plus resonances attributable to the presence of residual THF. The THF may be present as part of the crystalline lattice, as the material subjected to drying under vacuum at a slightly elevated temperature for relatively prolonged periods still shows the proton NMR signals of THF. FIG. 2 shows the infrared (IR) absorption spectrum of the crystalline form. A strong carbonyl band for the amide bond around 1620 cm⁻¹ is observed. FIG. 3 shows a Differential

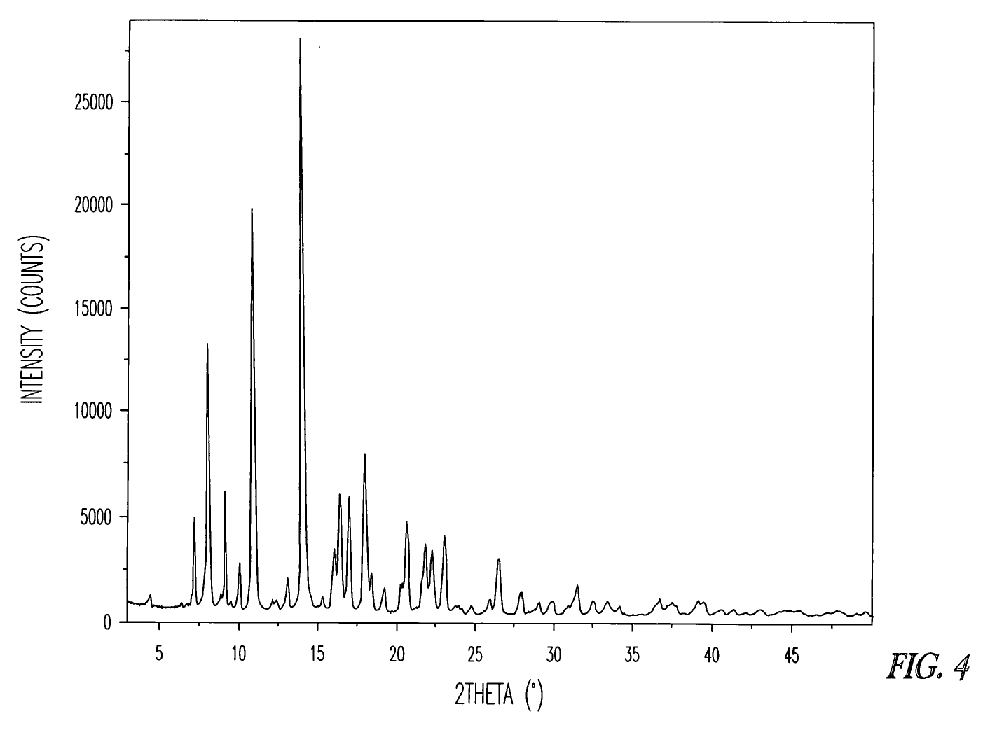

Scanning Calorimetry (DSC) trace for the crystalline form. A strong, single endotherm at about 157° C. is observed. FIG. 4 shows an X-ray powder diffraction pattern obtained from the crystalline form. Strong scattering peaks at 2θ values of about 7, 12, 14, 16, 18, and 21° are observed.

An embodiment of the invention provides a method of preparation of the inventive crystalline form. The method includes a step of crystallization of the product from tetrahydrofuran. In the Examples, exemplary procedures are given for the synthesis of the crude material and its purification by crystallization from THF, providing the inventive crystalline form of the compound. The compound of formula (VI) is prepared by condensing N,N′-bis-carbobenzyloxy pyrrolidin-3-ylglycine (III) with a diastereomerically pure pinanediol boronate ester of boroproline, compound (IV), to provide the bis-carbobenzyloxy protected compound (V), followed by removal of the carbobenzyloxy groups to yield compound (VI). The crude product (VI) is purified by crystallization from THF to provide the inventive crystalline form.

The conversion of precursor compound (V) to crude compound (VI) can be carried out by hydrogenation in methanol, or in another alcohol such as ethanol or isopropanol. The crude compound (VI), after removal of the catalyst, such as by filtration, is present as a methanol (or other alcohol) solution. The methanol (b.p. 65° C.) can be removed by evaporation, and the residue dissolved in THF. Alternatively, the methanol can be removed by direct solvent exchange with THF, wherein THF (b.p. 67° C.) is added to the methanol solution of compound (VI), and the mixture is repeated distilled and fresh THF added, until the methanol content is sufficiently low for crystallization of the THF solvate of compound (VI) to take place. The methanol/tetrahydrofuran azeotope boils at 60.7° C. under atmospheric pressure and contains 31% methanol (see U.S. Pat. No. 5,559,254). Crystallization can be achieved by concentration of the solution by removal of THF, for example by distillation, such as by distillation under reduced pressure, such as at an elevated temperature. For example, a temperature of about 45-50° C. can be used. The solution is then cooled so crystallization can occur. For example, the solution can be cooled to temperatures of about 0-25° C.

The diastereomerically pure starting material (IV), 2-(R)-boroproline-(1S,2S,3R,5S)-pinanediol ester, used in the condensation with (III), is itself prepared by selective crystallization of one diastereomer of the diastereomeric mixture formed by condensation of racemic boroproline and (+)-pinane-2,3-diol. The preferentially crystallizing diastereomer, under the conditions used, provides a boroproline moiety of the 2(R) absolute configuration, which is carried on through to the DPP-IV inhibitory compound (IA), 2(R)-1-{[(3R)-pyrrolidinylamino]-acetyl}-pyrrolidine-2-boronic acid.

Another embodiment of the invention provides a method of preparing a DPP-IV inhibitory compound of formula (IA) from the inventive crystalline form.

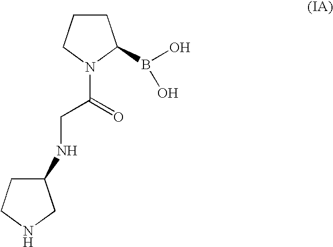

The compound of formula (IA), 2(R)-1-{[(3R)-pyrrolidinylamino]-acetyl}-pyrrolidine-2-boronic acid, can be prepared from the crystalline form of compound (VI) by a step of hydrolysis of the pinanediol boronate ester in an acidic aqueous medium. The acidic aqueous medium can include phenylboronic acid, which forms a cyclic boronate ester byproduct with the pinanediol by transesterification. The acidic aqueous medium can also include tartaric acid, allowing the tartrate salt of compound (IA) to be obtained from the aqueous phase. The step of hydrolysis can be carried out at temperatures of less than about 30° C., for times of not less than 1 hr. The byproduct pinanediol phenylboronate can be extracted from the aqueous phase with an organic solvent. For example, the byproduct can be extracted from the aqueous phase with MTBE. After extraction of impurities a solid form of compound (IA) is isolated from the aqueous phase by freeze drying or by spray drying. When tartaric acid is present, the dried material is the tartrate salt of compound (IA). The inventive method can provide the compound of formula (IA) tartrate salt with a purity in excess of 99%.

### Examples

### Abbreviations:

Cbz Carbobenzyloxy
EDAC 1-(3,3-dimethylaminopropyl)-3-ethyl-1,3-carbodiimide
HOBt N-Hydroxybenztriazole

MTBE Methyl t-butyl ether, methyl-tent-butyl ether
NMM N-methylmorpholine
THF Tetrahydrofuran

### Synthetic Scheme

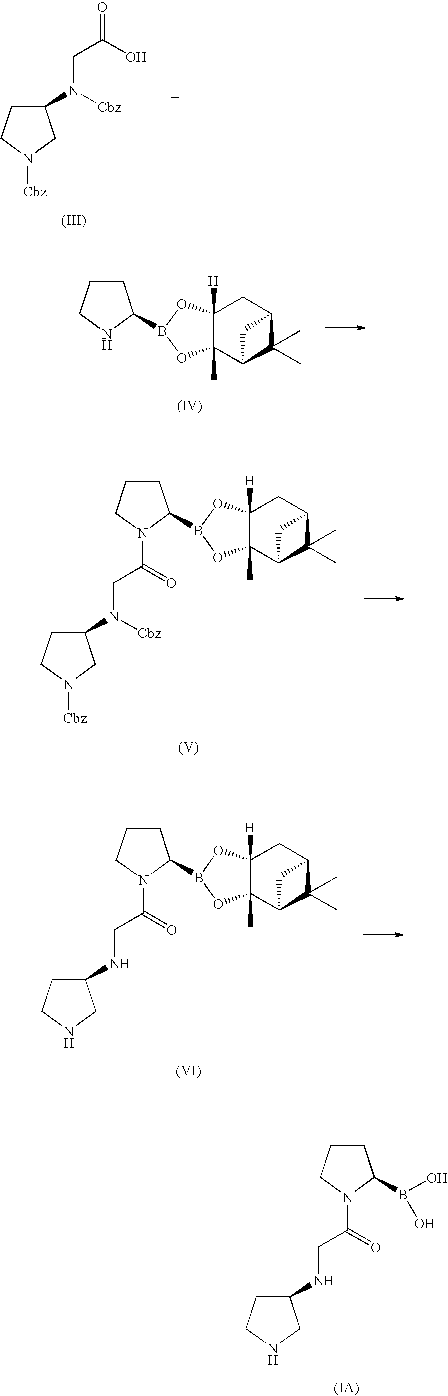

### Example 1

### Preparation of Compound (VI)

A sample of compound (III) (1.0 kg), plus dichloromethane (9.9 kg) and 1-hydroxybenzotriazole monohydrate (0.46 kg) are charged to a reactor, which is then cooled to 15-25° C. and stirred for at least 30 minutes, then further cooled to 0-5° C. EDAC (0.48 kg) is then added while maintaining the temperature, rinsing the charging device with dichloromethane (0.83 kg). Then, NMM (0.58 kg) is added, maintaining the temperature of the reaction mixture at 0-5° C., and the charging device is then rinsed with dichloromethane (0.83 kg). The pinanediol boronate ester (IV) (0.65 kg) is added, maintaining the temperature of the reaction mixture at 0-5° C., and the charging device then rinsed with dichloromethane (0.83 kg). The reaction mixture is stirred at 0-5° C. for at least 4 hours, then the temperature is raised to 15-25° C. and stirred at least an additional 6 hours until the reaction is complete, as determined by HPLC (<2% remaining compound (III)). If necessary, additional NMM, EDAC, and compound (IV) are added to bring the reaction to completion. Then, the reaction mixture is concentrated under vacuum at a temperature no greater than 25° C. until the total volume of about 4.5 L is achieved. Then, ethyl acetate (11.8 kg) is added, followed by an aqueous sodium bicarbonate solution previously prepared by dissolving sodium bicarbonate (0.37 kg) in deionized water (5.2 L). During addition of the sodium bicarbonate solution the reaction mixture is maintained at a temperature of 15-25° C. The two-phase mixture is stirred at least ten minutes, then stirring ceased and the phases allowed to separate for at least ten minutes. The aqueous (lower) layer is discharged, and a previously prepared solution of sodium bicarbonate (0.18 kg) in deionized water (2.5 L) is added, stirred at least ten minutes, and the phases allowed to separate at least ten minutes, all at 15-25° C. Then, the aqueous (lower) phase is discharged, and a previously prepared solution of citric acid (0.05 kg) in deionized water (4.0 L) added to the organic phase, the two phases stirred at least ten minutes and then allowed to separate at least ten minutes, then the aqueous (lower) phase is discharged. The organic phase is analyzed by HPLC, and if the remaining content of compound (III) is greater than 0.5%, the sodium bicarbonate extractions are repeated. Then, the organic phase is washed with deionized water (5.0 L) for ten minutes with stirring, followed by at least ten minutes of phase separation. The aqueous (lower) phase is discharged, and the organic phase concentrated under vacuum at a temperature not exceeding 35° C. to a final volume of about 1.7 L. This solution of compound (V) is used directly in the next step.

Methanol (5.5 kg) is then added to the solution of compound (V) in residual ethyl acetate (volume 1.7 L) in a pressure reactor, maintaining the temperature at 15-25° C. and stirring for at least 15 minutes. Then, 5% palladium on carbon (0.04 kg) is added, and the charging system rinsed with additional methanol (0.7 kg). The reaction mixture is then stirred at 15-30° C. under 3-9 bar hydrogen gas (preferably 3-5 bar), until HPLC showed less than 0.4% starting material. The reaction mixture is then filtered through a bed of cellulose (3 kg) and anhydrous sodium sulfate (0.4-1.7 kg), and through a filter with a porosity of at least 0.45 microns. The reactor and filters are washed with methanol (1.0 kg), adding the rinse to the filtrate. The filtrate is concentrated under vacuum at a temperature not exceeding 35° C. to a volume of about 2.0 L. Then, THF (7.0 kg) is added to the concentrated filtrate, and the total volume again reduced under vacuum to about 2.0 L. This is repeated until the methanol content was less than 0.5% as determined by gas chromatography (GC). Then, the solution is cooled to −5° C. to −10° C. and stirred for at least 30 minutes. The suspension is filtered and the filter cake washed with THF (0.27 kg) that is previously cooled to −5° C. to −10° C. The filter cake is dried under vacuum at a temperature not exceeding 40° C. until the loss on drying is less than 2% w/w. The product in crystalline form is about 97-98% pure, with the exception of included THF.

### Example 2

### Crystallization of Compound (VI)

Compound (VI) (1.0 kg) is charged to a reactor, followed by between 21.4 and 24 L THF. The mixture is heated at 40-45° C. for at least 2 hours to dissolve the solid. Then, the mixture is concentrated under vacuum at a temperature not exceeding 45° C. until a volume of 4.2-4.5 the quantity of compound (VI) is achieved, then the mixture is cooled to 18-20° C. and stirred at least 2 hours. The precipitated solid is filtered out and the filter cake washed with THF (0.89 kg) previously cooled to 18-22° C. The cake is dried under vacuum at a temperature not exceeding 40° C. until the loss on drying is less than 2% w/w. The product in crystalline form is believed to be at least 99% pure, with the exception of included THF.

### Example 3

### Conversion of Compound (VI) to Compound (IA)

Compound (VI) in crystalline form (1.0 kg) of at least 98% purity is charged to a reactor, followed by tartaric acid (0.4 kg) and purified water (2.0 L). The mixture is agitated at a temperature not exceeding 30° C. for at least one hour. Then, phenylboronic acid (0.33 kg) and MTBE (3.7 kg) are added and the mixture stirred at least 2 hours at 15-25° C. The mixture is analyzed by HPLC until less than 0.5% starting material remains. Then, stirring is ceased and the layers are allowed to separate for at least 15 minutes, and the organic (upper) layer discharged. Then, MTBE (3.7 kg) is added and the mixture stirred at least 10 minutes, and the phases allowed to separate at least 15 minutes. The organic (upper) layer is discharged, and the extraction with MTBE is repeated at least twice, retaining the aqueous (bottom layer) at each step. The aqueous solution is filtered and kept under a vacuum of −0.8 to −0.9 bar for 2 hr at 35-50° C. to remove solvent traces. The solution is transferred to freeze dryer trays and the water removed by freeze drying. Compound (IA) as the tartarate salt is obtained. Purity is in excess of 99% as determined by HPLC.

### Example 4

### Evaluation of Experimental Parameters for THF Crystallization

A representative crude purity profile of the compound (VI) prior to purification is shown in the shaded area in the table below. The basic process involves dissolving the crude material in THF at about 35° C., holding for 5 hours, cooling to about 20° C. then filtering. The purity of both crude and purified compound (VI) was determined by converting the purified compound (VI) to compound (IA) (as the tartrate salt) then analyzing the material using HPLC.

Using 5 volumes of THF per gram of compound (VI) (Experiment 1) resulted in significant improvement of the impurity profile for final product (IA) tartrate salt; however, the yield for this process was 51%. Starting with 24 volumes of THF (Experiment 2) per gram of compound (VI) then concentrating to 5 volumes after the hold time at 35° C. afforded a 70.6% yield and excellent purity of compound (IA) tartrate salt. Experiment 3 started with 24 volumes of THF and concentrated to 4 volumes affording a yield of 85.6% and good purity (99.0%) though slightly less pure than purity numbers for Experiment 1.

Subsequent efforts demonstrated that a 2-hour hold time at 40-45° C., followed by vacuum concentration at the same temperature range, and finally cooling to 20-25° C. then holding for 2 hours produced the optimum yield and purity for compound (IA) tartrate salt.

TABLE
HPLC analyses of compound (IA) tartrate prepared from
compound (VI) samples obtained from Experiments 1-3.

| | | | | (VI) | |
|---|---|---|---|---|---|
| | THF | Hold | Isolation | Purified | (IA) |
| | volume | Temp | Temp | Yield | HPLC |
| Description | (mL/g) | (° C.) | (° C.) | (%) | Purity |
| crude compound (VI) | | | | | 91.98 |
| Experiment 1 | 5 x | 35 | 20 | 51.2 | 98.88 |
| Experiment 2 | 24 x to 5 x | 45 | 20 | 70.5 | 99.53 |
| Experiment 3 | 24 x to 4 x | 45 | 20 | 85.6 | 99.02 |

All publications, patents, and patent documents cited in the specification are incorporated by reference herein, as though individually incorporated by reference. In the case of any inconsistencies, the present disclosure, including any definitions therein, will prevail. The invention has been described with reference to various non-limiting examples and embodiments. However, it should be understood that many variations and modifications may be made while remaining within the spirit and scope of the present invention.

1. A crystalline form of a compound of formula (VI):

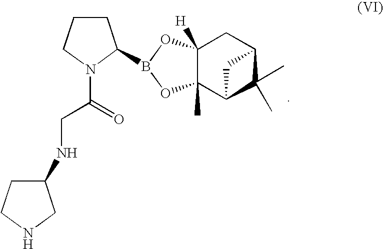

2. The crystalline form of the compound of claim 1 comprising included solvent.

3. The crystalline form of the compound of claim 2 wherein the solvent comprises tetrahydrofuran.

4. The crystalline form of the compound of claim 1 comprising a tetrahydrofuran solvate of the compound of formula (VI).

5. The crystalline form of the compound of claim 1 prepared by crystallization from tetrahydrofuran.

6. The crystalline form of the compound of claim 1 having substantially the NMR spectrum of FIG. 1.

7. The crystalline form of the compound of claim 1 having substantially the IR spectrum of FIG. 2.

8. The crystalline form of the compound of claim 1 having substantially the DSC trace of FIG. 3.

9. The crystalline form of the compound of claim 1 having substantially the X-ray powder diffraction pattern of FIG. 4.

10. The crystalline form of the compound of claim 1 of purity greater than or equal to 97%, or 98%, or 99%.

11. A method of preparing the crystalline form of the compound of claim 1, comprising dissolving an unpurified sample of the compound of formula (VI) in tetrahydrofuran at an elevated temperature to form a solution, then, cooling the solution to a low temperature sufficient for crystallization of the crystalline form to take place, then, collecting the crystalline form.

12. The method of claim 11, further comprising preparation of the unpurified sample of the compound of formula (VI) from a precursor compound of formula (V): 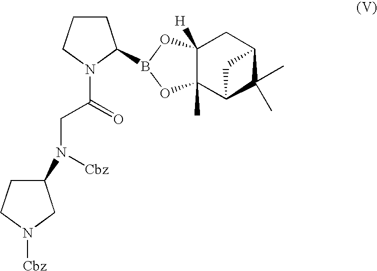
wherein Cbz signifies a carbobenzyloxy group,
by hydrogenation in methanol, or in other alcohol solvent, followed by solvent exchange to THF, wherein the methanol content is reduced by repeated addition and distillation of THF and methanol or other alcohol solvent to provide compound (VI) in tetrahydrofuran.

13. The method of claim 11, comprising, after forming the solution, a step of concentrating the solution by distillation of a portion the tetrahydrofuran from the solution.

14. The method of claim 13 wherein the step of distillation comprises distillation under reduced pressure.

15. The method of claim 11 further comprising, after collecting the crystalline form, drying the crystalline form.

16. The method of claim 11 wherein the elevated temperature is about 40-45° C.

17. The method of claim 11 wherein the low temperature is about 0-25° C.

18. A crystalline form of a compound of formula (VI) prepared by the method of claim 11.

19. A method of preparing a DPP-IV inhibitory compound of formula (IA): 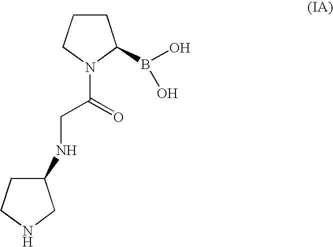
comprising contacting the crystalline form of the compound of claim 1 with an acidic aqueous medium to provide the compound of formula (IA) or a salt thereof.

20. The method of claim 19, wherein the acidic aqueous medium comprises tartaric acid.

21. The method of claim 19, wherein the acidic aqueous medium comprises phenylboronic acid.

22. The method of claim 19, wherein contacting comprises contacting at a temperature not exceeding 30° C. for a period of not less than one hour.

23. The method of claim 19, further comprising, after the step of contacting, a step of extracting impurities and reaction byproducts with an organic solvent.

24. The method of claim 23 wherein the organic solvent comprises MTBE.

25. The method of claim 20, further comprising, after the step of contacting, a step of freeze drying or spray drying the acidic aqueous medium containing the compound of formula (IA) to provide the compound of formula (IA) as a tartarate salt.

26. The tartarate salt of the compound of formula (IA), prepared by the method of claim 20 or 25.
